(19) United States
(12) Patent Application Publication
(10) Pub. No.: US 2016/0371581 A1
(43) Pub. Date: Dec. 22, 2016

(54) CUSTOMIZABLE EXTENSIONS FOR VIRTUAL ASSISTANTS

(71) Applicant: Lenovo (Singapore) Pte. Ltd., Singapore (SG)

(72) Inventors: Rod D. Waltermann, Rougemont, NC (US); Hermann Franz Burgmeier, Chapel Hill, NC (US); Timothy Winthrop Kingsbury, Cary, NC (US)

(21) Appl. No.: 14/744,820

(22) Filed: Jun. 19, 2015

(51) Int. Cl. G06N 3/00

(52) U.S. Cl. CPC G06N 3/006

(57) ABSTRACT

One embodiment provides a method, including: receiving, at a virtual assistant running on an electronic device, a user input; processing, using the virtual assistant, the user input; processing, using a module running in parallel to the virtual assistant, the user input; combining, using a processor, a response to the user input issued by the virtual assistant and a response to the user input issued by the module; and providing an integrated response to the user input. Other aspects are described and claimed.

### BACKGROUND

Electronic devices (e.g., tablet devices, smart phones, smart watches, laptop computers, personal computers, etc.) sometimes include virtual assistant products from companies such as Apple Inc., Microsoft Inc., and Google Inc. The virtual assistant products are often provided as a stock application, e.g., included with device software from the device manufacturer. Virtual assistants act as a device assistant, where the user may provide input to the virtual assistant and have the virtual assistant provide a response to the input. Often users employ the virtual assistant as an entrance point to obtain information or even to complete a task. For example, a user may input (e.g., using voice, text, etc.) a general knowledge question to the virtual assistant, with the virtual assistant conducting an Internet search to compose a response to the question.

### BRIEF SUMMARY

In summary, one aspect provides a method, comprising: receiving, at a virtual assistant running on an electronic device, a user input; processing, using the virtual assistant, the user input; processing, using a module running in parallel to the virtual assistant, the user input; combining, using a processor, a response to the user input issued by the virtual assistant and a response to the user input issued by the module; and providing an integrated response to the user input.

Another aspect provides an electronic device, comprising: an input device; an output device; a processor operatively coupled to the input device and the output device; and a memory that stores instructions executable by the processor to: receive, at the input device, a user input to a virtual assistant; process, using the virtual assistant, the user input; process, using a module running in parallel to the virtual assistant, the user input; combine a response to the user input issued by the virtual assistant and a response to the user input issued by the module; and provide, using the output device, an integrated response to the user input.

Another aspect provides a method, comprising: presenting an opportunity to download a module; the module running in parallel with a virtual assistant; the module processing user input provided to a virtual assistant; and the module producing a response to the user input for integration with a response provided by a virtual assistant.

A further aspect provides an apparatus comprising: a first processor; a network adapter; and storage bearing instructions executable by a second processor for: storing a module that runs in parallel with a virtual assistant; the module processing user input provided to a virtual assistant; and the module producing a response to the user input for integration with a response provided by a virtual assistant; wherein the first processor transfers the instructions over a network via the network adapter.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of electronic device circuitry.

FIG. 2 illustrates another example of electronic device circuitry.

FIG. 3 illustrates an example method of employing a virtual assistant extension.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Virtual assistant software applications (such as SIRI and GOOGLE NOW virtual assistants) offer services within a well specified range of functionality. This is because virtual assistants are designed to include core functionality aimed at the general population. For example, typical examples of functionality within the standard range include performing web searches and reminding the user of upcoming calendar events. These virtual assistants, however, are often unable to offer high quality responses to requests that are outside of the particular range of functionality. This is because conventionally virtual assistants are designed to be used in a general capacity, with there being only one type of virtual assistant per maker. For example, there are not different versions of virtual assistant available from the same provider. SIRI is a registered trademark of Apple, Inc. GOOGLE NOW is a registered trademark of Google, Inc.

Accordingly, an embodiment provides a mechanism to extend the functionality of a virtual assistant, optionally in ways that are transparent to the user. For example, the virtual assistant may be designed to support a mechanism (termed herein a module) that allows additional functionality to be added, e.g., added by the user after the virtual assistant has already been deployed on the device. The module, in essence, makes the virtual assistant more intelligent by adding customized functionality not contemplated or appropriate for a general use virtual assistant.

In an embodiment, user inputs (e.g., requests) that are submitted to the virtual assistant are also submitted to the module. Results from the module may thus be returned along with the regular results from the standard, stock virtual assistant. Depending on the nature of the results desired, the module results and the virtual assistant results may be combined, with the combination optionally being transparent to the user, e.g., the user may be provided with a combined response from the virtual assistant without specific reference to which result(s) or response was/were obtained by the module or that any results were obtained by the module. In an embodiment, the user may be unaware that a module is even being employed.

In terms of the response provided to the user, a normalized weighting system may be used to allow the additional results of the module to be mixed together with the standard results of the virtual assistant. If the additional results are strongly weighted, they may take precedence over the standard results and may be displayed in a more prominent location. There may be no need for a clear separation between the standard results and the extended (module) results that are provided.

Typically virtual assistant software will respond to requests that are not properly recognized with a default response, e.g., generic keyword search results from a common web search engine. Another possibility is to pass the query along to a more specialized natural language processing engine such as WOLFRAM ALPHA search engine. However, these approaches fall well short of what would be possible if the request was properly recognized and processed in the most optimal way.

An embodiment therefore extends a virtual assistant's functionality and thus quality with specialized abilities to service requests that are about a very specific body of knowledge, i.e., a functionality that goes beyond what the original developers of the virtual assistant have implemented for the general use virtual assistant. Via access to specialized knowledge sources (such as topical data feeds, specialized lexicons or data sets, etc.) as well as customized, preprogrammed topical functions, an embodiment facilitates the boosting of virtual assistant performance. Such modular extension of the general virtual assistant may be matched to a user's particular interests or needs. For example, a user may be offered a variety of modular extensions that may be added to increase the virtual assistant's knowledge and functionality in a particular area.

As an example, a modular extension may include a car buying assistance module. This module, rather than the virtual assistant's core functionality, may include detailed knowledge of (access to data regarding) used car values, new car values, dealer invoice prices, etc. By virtue of access to such specialized knowledge, the module is able to supplement the virtual assistant's responses to a user's input. As another example, a sports statistics module may include, rather than the virtual assistant's core functionality, detailed knowledge of recent and past performance of players in a specific sport. Again, by virtue of access to such specialized data, the module may supplement the virtual assistant's response to a user's query for particularized sports statistics. As another example, a grocery shopping assistance module may include, rather than the virtual assistant's core functionality, detailed knowledge of current grocery prices, sales and coupons. The search results issued by the virtual assistant therefore may be supplemented with topical, localized or otherwise specialized results that typically would not be available.

The results issued by the virtual assistant, with the assistance of the module, may be expressed to the user in a variety of ways. For example, detailed lists, concise short answers, or spoken answers may be provided. The user does not need to be concerned that the results are coming from an extension that was added to the virtual assistant.

The illustrated example embodiments will be best understood by reference to the figures. The following description is intended only by way of example, and simply illustrates certain example embodiments.

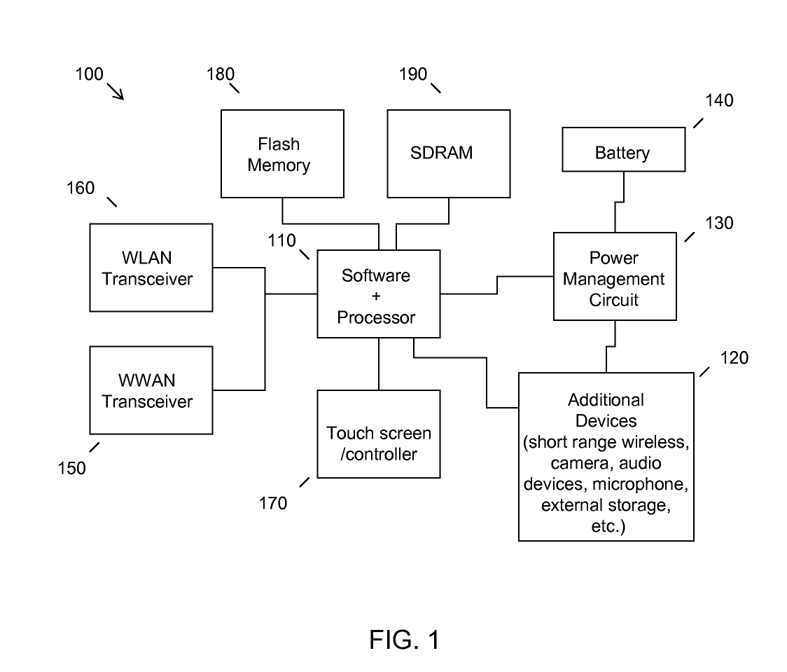

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an audio receiver such as a microphone that operates with a speech processing system for providing voice input and related data to a virtual assistant application, etc. System 100 often includes a touch screen 170 for data input and display/rendering. System 100 also typically includes various memory devices, for example flash memory 180 and SDRAM 190.

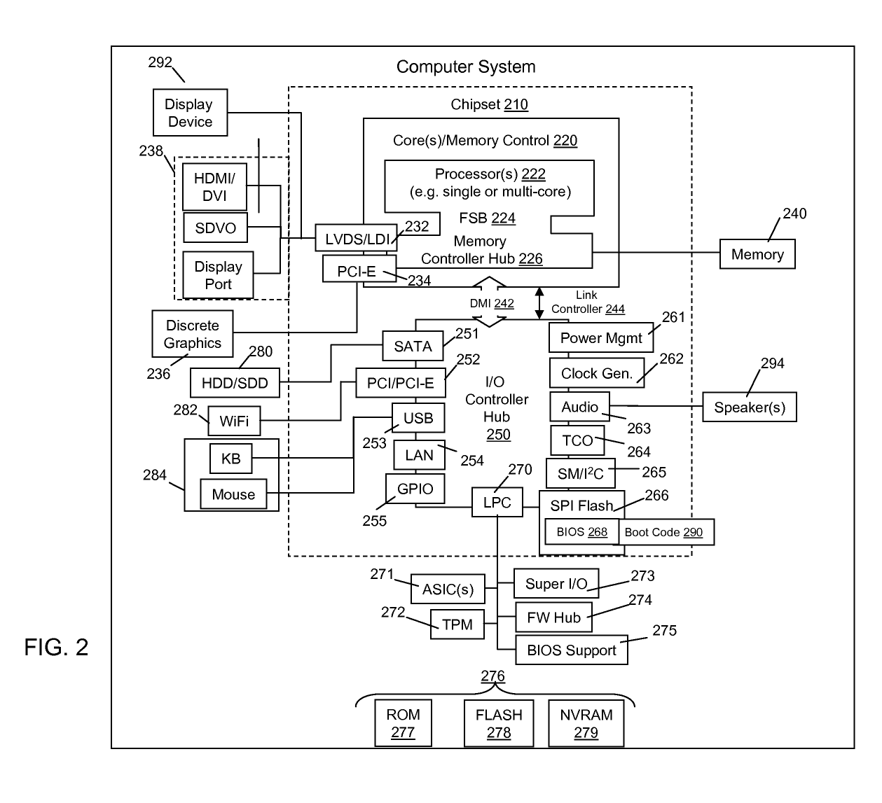

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, laptop or other personal computing devices generally, and/or other electronic devices to which users may provide inputs to a virtual assistant application. The circuitry outlined in FIG. 1 and/or FIG. 2, or combination or modification thereof, may be used to implement the functionality of the virtual assistant application and its modular extension(s), as further described herein.

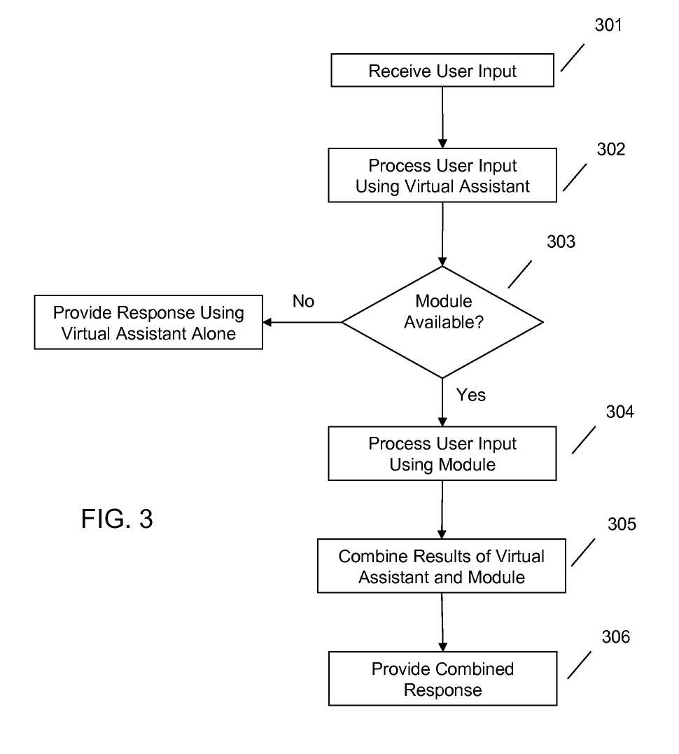

By way of example, and referring to FIG. 3, an embodiment receives a user input at a virtual assistant running on an electronic device at 301. Typically, the virtual assistant application would process the input in accordance with its programming, which is designed for general use. Thus, when faced with a particularized question, e.g., about sports, medicine, local shopping sales, etc., the best hoped for result is a web search using whatever key word(s) might have been included in the user input received at 301. In an embodiment, this standard processing continues to take place, as indicated at 302. In some cases, this processing cannot be supplemented or the same result will be achieved by the module and the virtual assistant.

However, if one or more modular extensions of the virtual assistant are available, as determined at 303, an embodiment offers parallel processing of the user input using a module running on the device, as indicated at 304 (with the understanding that “parallel” processing may in fact include serial processing and likewise running in “parallel” may include running of code serially). If no additional module is available, the standard virtual assistant response may be issued, as illustrated.

If a module is available, as determined at 303, an embodiment processes the user input with the modular extension, as indicated at 304. This processing may include processing the actual user input, e.g., similar to the processing applied by the virtual assistant, or accessing the user input (or data derived there-from), e.g., from the virtual assistant. In any event, the module employs its own processing in an effort generate results, e.g., more results, more accurate results, refined response(s) to the user's input, etc.

The result(s) that is/are generated by the module may be combined with those of the virtual assistant, as indicated at 305, in order to provide a combined response, as indicated at 306. It should be noted that the “combined” response provided at 306 may be a single result or response, which may be obtained from either the virtual assistant or the modular extension thereof. By way of example, in the process of combining the results at 305, it may be determined that the user input calls for a single response. In this event, the results may be combined and a superior, e.g., higher ranked, result is issued as the response. Alternatively, e.g., in the case where a results list is provided as a response, a true combined results list may be provided at 306 (e.g., mixed results from the module and the virtual assistant). As may be appreciated, depending on the ranking of combined results, all, some or none of the combined response results provided at 306 may be issued from the module or the virtual assistant.

In terms of processing the user input using a module, as illustrated at 304, the module may accesses or include a custom knowledge source not available to the virtual assistant. For example, the virtual assistant is designed to respond to user inputs issued by the general population. However, certain sub-sets of the population, e.g., doctors, sports enthusiasts, those interested in shopping in a particular category of products, etc., may be interested in customized knowledge. Thus, the module may include or have access to such customized knowledge and data sources, whereas a typical virtual assistant would never be programmed to include such extensive knowledge or to access such data.

By way of example, the custom knowledge source that is associated with the module may include a topical knowledge source, e.g., specialized medical knowledge, specialized local knowledge, etc., and may also include a knowledge source that is updated more frequently than generally available Internet data, e.g., the knowledge source may include a topical data feed, a proprietary database, etc. This permits a more specialized response to be issued by the virtual assistant than would otherwise be available.

In an embodiment, an offering of one or more modules may be made to the user such that the user is in control of how the virtual assistant is customized. For example, an embodiment may offer a download of a variety of modules and/or may include a set of modules with the device that may be activated by the user. This permits the user to flexibly select from among a plurality of module versions, depending on the user's needs and interests. Thus, each of the plurality of module versions may include custom modules built to use different knowledge sources, e.g., have access to custom data feeds for different topical categories, access to custom logic or programming designed for a particular use or user, etc.

A modular extension to a virtual assistant may be offered to and/or activated by the user. For example, a modular extension may be included with a virtual assistant and later activated by a user. The activation may be automated, e.g., by processing instructions to activate a module if a virtual assistant cannot offer a high confidence response to a user query.

A modular extension may be offered together or separately as a download to a user. In an embodiment, a method may include receiving, over a network connection, a module that runs in parallel with a virtual assistant; and storing, in a local storage, the module; the module processing user input provided to a virtual assistant; and the module producing a response to the user input for integration with a response provided by a virtual assistant. For example, an embodiment may include a client device receiving the module over a network connection, e.g., a download. Further, the client device may receive a virtual assistant, before, during or after the receipt of the module.

A modular extension may be offered to the user, e.g., by operating a service wherein downloadable modules may be selected for download to a user, e.g., over an Internet connection. Thus, an embodiment may include an apparatus comprising: a first processor; a network adapter; and storage bearing instructions executable by a second processor for: storing a module that runs in parallel with a virtual assistant; the module processing user input provided to a virtual assistant; and the module producing a response to the user input for integration with a response provided by a virtual assistant; wherein the first processor transfers the instructions over a network via the network adapter. For example, a network server may include the network adapter and storage, and provide a module to a second processor (e.g., of a client device) using a network connection.

As may be appreciated then, an embodiment facilitates customized extension of a virtual assistant such that the functionality and capabilities of the virtual assistant are supplemented. By allowing the user to be involved in the selection of a modular extension, the virtual assistant's functions may be matched more closely to the needs and desires of the user. This modular approach also frees virtual assistant designers to focus on core functionality rather than being concerned about specialized functionality that may be applicable to only a small sub-set of users.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, at a virtual assistant running on an electronic device, a user input;
processing, using the virtual assistant, the user input;
processing, using a module running in parallel to the virtual assistant, the user input;
combining, using a processor, a response to the user input issued by the virtual assistant and a response to the user input issued by the module; and
providing an integrated response to the user input.

2. The method of claim 1, further comprising offering one or more of download of the module and an activation of the module.

3. The method of claim 2, wherein the offering comprises offering a plurality of module versions.

4. The method of claim 3, wherein the plurality of module versions comprise custom modules built to use different knowledge sources.

5. The method of claim 4, wherein the different knowledge sources comprise custom data feeds for different topical categories.

6. The method of claim 1, wherein the module accesses a custom knowledge source not available to the virtual assistant.

7. The method of claim 6, wherein the custom knowledge source is associated with the module.

8. The method of claim 7, wherein the knowledge source comprises a topical knowledge source.

9. The method of claim 7, wherein the knowledge source comprises a topical data feed.

10. The method of claim 1, further comprising downloading the module over a network after the virtual assistant is added to the device.

11. An electronic device, comprising:
an input device;
an output device;
a processor operatively coupled to the input device and the output device; and
a memory that stores instructions executable by the processor to:
receive, at the input device, a user input to a virtual assistant;
process, using the virtual assistant, the user input;
process, using a module running in parallel to the virtual assistant, the user input;
combine a response to the user input issued by the virtual assistant and a response to the user input issued by the module; and
provide, using the output device, an integrated response to the user input.

12. The electronic device of claim 11, wherein the instructions are executable by the processor to offer one or more of a download of the module and an activation of the module.

13. The electronic device of claim 12, wherein to offer comprises offering a plurality of module versions.

14. The electronic device of claim 13, wherein the plurality of module versions comprise custom modules built to use different knowledge sources.

15. The electronic device of claim 14, wherein the different knowledge sources comprise custom data feeds for different topical categories.

16. The electronic device of claim 11, wherein the module accesses a custom knowledge source not available to the virtual assistant.

17. The electronic device of claim 16, wherein the custom knowledge source is associated with the module.

18. The electronic device of claim 17, wherein the knowledge source comprises a topical knowledge source.

19. The electronic device of claim 17, wherein the knowledge source comprises a topical data feed.

20. A method, comprising:
presenting an opportunity to download a module;
the module running in parallel with a virtual assistant;
the module processing user input provided to a virtual assistant; and
the module producing a response to the user input for integration with a response provided by a virtual assistant.

21. The method of claim 20, further comprising presenting an opportunity to download a virtual assistant that runs in parallel to the module.

22. An apparatus comprising:
a first processor;
a network adapter; and
storage bearing instructions executable by a second processor for:
storing a module that runs in parallel with a virtual assistant;
the module processing user input provided to a virtual assistant; and
the module producing a response to the user input for integration with a response provided by a virtual assistant;
wherein the first processor transfers the instructions over a network via the network adapter.
